(19) United States
(12) Patent Application Publication
(10) Pub. No.: US 2024/0098806 A1
(43) Pub. Date: Mar. 21, 2024

(54) SERVICE DATA FLOW CONTINUITY FOR A UE IN A SYSTEM INVOLVING A GATEWAY DEVICE

(71) Applicants: Koninklijke KPN N.V., Rotterdam (NL); Nederlandse Organisatie Voor Toegepast-Natuurwetenschappelijk Onderzoek TNO, ,s-Gravenhage (NL)

(72) Inventors: Toni DIMITROVSKI, Boskoop (NL); Sanne Jacomine THEPASS, The Hague (NL)

(21) Appl. No.: 18/038,411

(22) PCT Filed: Nov. 22, 2021
(86) PCT No.: PCT/EP2021/082503

§ 371 Date: May 23, 2023

(30) Foreign Application Priority Data
Nov. 24, 2020 (EP) 20209384.5

(51) Int. Cl. H04W 76/10; H04W 8/26

(52) U.S. Cl. CPC H04W 76/10; H04W 8/26; H04W 88/16

(57) ABSTRACT

One aspect of this disclosure pertains to a UE configured for controlling connection continuity in a system comprising a first gateway device having a first established PDU session with a telecommunications network storing a first session management context for the first gateway device associated with the first established PDU session and providing a local network for a plurality of UEs using the first established PDU session of the first gateway device and a further device having a second established PDU session with the telecommunications network storing a second session management context associated with the second established PDU session. The UE is configured to control connection continuity by transmitting a PDU session modification request to the telecommunications network comprising a reference to first PDU session information in the first session management context stored in the telecommunications network for the UE to include at least part of the first PDU session information in the second session management context. Alternatively or in addition, the UE may be configure to transmit an access request to the first gateway device comprising a reference to second PDU session information in the second session management context stored in the telecommunications network to include at least part of the second PDU session information in the first session management context.

### TECHNICAL FIELD

The present disclosure relates to a UE, a gateway device and a session management system enabling service data flow continuity. In particular, the disclosure relates to service data flow (SDF) continuity for a user equipment (UE) moving between a 5G residential gateway (5G-RG) and a 5G telecommunications network or another 5G residential gateway.

### BACKGROUND

Home devices are usually connected to the internet via a device referred to as gateway device or residential gateway (RG). The gateway device provides a local network and assigns IP addresses to devices in the local network. The gateway device routes data traffic in and out of the local network. The gateway device may contain a wireless access part, using e.g. WiFi access technology.

The 5G-RG is a Residential Gateway that connects to the 5G core network (5GC) as a UE to represent the devices in the local network. In this manner, the devices (also referred to as UEs) behind the 5G-RG can have a connection to a data network via the 5G-RG without being registered in the 5GC. 3GPP TS 23.316 v16.5.0 specifies such a network arrangement.

The 5G-RG provides access to multiple UEs using a single PDU session that is established for the 5G-RG with a /32 IPv4 or /128 IPv6 address by means of e.g. a framed route making a range of IP addresses or IPv6 prefixes reachable over the single PDU session of the 5G-RG. The single PDU session has a single session management context stored in the 5GC which reduces administrative processing (aggregated traffic counting, charging, etc.) in the 5GC as opposed to having a separate PDU session for each device in the local network. With the framed route, for example, the 5GC can route all data traffic for devices in the local network directly to the 5G-RG over the established single PDU session, wherein the 5G-RG then further forwards the data traffic to specific devices in the local network. This way, each device behind the 5G-RG can have a connection to a Data Network (DN) over the 5GC using its assigned IP address, without needing any address translation (e.g. NAT) and without being registered in the 5GC. However, in this case the devices themselves behind the 5G-RG may not have session management contexts in the 5GC because these devices use the PDU session of the 5G-RG.

### SUMMARY

In the network arrangement described above, it may occur that a UE moves out of coverage of the local network (or disconnects from it), and therefore cannot use the 5G-RG for this connection anymore.

The UE may also have an established PDU session with the 5GC for the data network (DN) when it is in or out of the coverage of the local network, such as a Personal IoT (Internet of Things) Network (PIN). Normally, the UE would be able to perform a handover procedure to maintain connectivity as is defined in 3GPP TS 23.502 v16.3.0. However, in the network arrangement with the residential gateway described above, the UE in the local network is unknown to the 5GC from a PDU session perspective because the established PDU session is only for the 5G-RG and not for a dedicated UE. Although there are ways to perform mobility for the UE in this situation, these require the UE to create a new PDU session for the DNN and get a new address (e.g. an IP address) assigned from the 5GC, causing the previous connection to be broken. Furthermore, handover procedures are meant to transfer an existing PDU session, which in the case of a UE behind the 5G-RG doesn't exist. The 5G-RG itself should also keep its PDU session after a UE moves out because it may serve other devices in the local network as well.

Furthermore, 3GPP has developed a feature known as Access Traffic Steering, Switching, Splitting (ATSSS) that allows a UE to have a multi-access PDU Connectivity Service, which can exchange PDUs between the UE and a data network by simultaneously using one 3GPP access network and one non-3GPP access network using two independent tunnels in the 5GC. With ATSSS service data flows, SDFs, can be steered via the non-3GPP network when the UE is connected to this network according to ATSSS rules in the UE. However, with ATSSS, both the PDU session via the 3GPP access network and the PDU session via the non-3GPP access network terminate in, and are therefore under control of, the UE in contrast to the situations covered in the present application wherein at least one PDU session terminates in a gateway device and not in the UE.

It is an object of the present disclosure to enable a UE to move between a connection with a local network behind a gateway device and a connection with a telecommunications network (e.g. a 5G network) or a connection with another gateway device while continuing at least one service data flow after moving.

Hence, in one aspect, the present disclosure pertains to a user equipment, UE, configured for controlling connection continuity, for example service data flow continuity, in a system comprising:
a first gateway device having a first established packet data unit, PDU, session with a telecommunications network storing a first session management context for the first gateway device associated with the first established PDU session and providing a local network for a plurality of UEs using the first established PDU session of the first gateway device for data transfer over the telecommunications network; and
a further device, separate from the first gateway device, possibly already having a second established PDU session or configured for establishing this second PDU session with the telecommunications network storing a second session management context associated with the second established or to be established PDU session.

The further device may, for example, be the UE itself, a second gateway device or any other device being able to have an established PDU session with the 5GC.

When the further device is the UE itself, the UE may have the second established PDU session with the telecommunications network storing a second session management context associated with the second established PDU session. The second established PDU session may be devoid of any service data dataflow or quality of service, QoS, flow and thus represent an ‘empty’ PDU session. In one embodiment, the empty PDU session does not have a default SDF/QoS flow associated with an any PDU session. Such an empty PDU session may be beneficial to enable the UE to use the existing associated PDU session to include a service data flow in a swift manner to provide a quasi-continuous experience to the user. For example, the UE already has a session management context stored in the telecommunications network when the second established PDU session exists.

A second gateway device may also serve as the further device and may have the second established PDU session with the telecommunications network storing a second session management context associated with the second established PDU session. The second gateway device may provide a further local network for a plurality of UEs in addition to or as an extension of the local network provided by the first gateway device. The second session management context in this case includes the PDU session of the second gateway device that is used by UEs in the local network for data transmission to a data network over the telecommunications network and may therefore not be empty. The first and second gateway device may be located in the same premises, such as a house, hotel, hospital, etc., to offer mobility or better coverage over a larger area.

In one aspect of the present disclosure, the UE is configured to control connection continuity by transmitting at least one of:
a PDU session modification request to the telecommunications network comprising a reference to first PDU session information in the first session management context stored in the telecommunications network for the UE to include at least part of the first PDU session information in the second session management context; and
an access request to the first gateway device comprising a reference to second PDU session information in the second session management context stored in the telecommunications network to include the at least part of the second PDU session information in the first session management context.

In order to continue connectivity, at least in part, when the UE moves out of or disconnects from the local network provided by the first gateway device, the UE may be configured to transmit a PDU session modification request to the telecommunications network to modify its existing second PDU session, which may be empty as described above. To that end, the UE may include at least one reference to first PDU session information associated with the UE in the first session management context stored in the telecommunications network for the first gateway device. The PDU session information may include one, more or any (active) SDF(s) and/or QoS flow(s) associated with the UE when connected to the first gateway device. The reference to the PDU session information enables the telecommunications network (e.g. a session management system thereof) to trace PDU session information stored therein associated with the UE. The PDU session information associated with the UE, or a part thereof, may then be branched out of the first session management context associated with the first established PDU session of the first gateway device and be included in the second session management context associated with the second, possibly empty, established PDU session of the UE.

Reversely, when the UE moves into the local network of the first gateway device, the UE may be configured to transmit an access request to the first gateway device to get connected to the local network. The UE may be configured to include, in the access request or in another request, a reference to second PDU session information associated with the UE that is stored in the telecommunications network. The PDU session information may include one, more or any (active) SDF(s) and/or QoS flow(s) associated with the UE when connected to the telecommunications network or associated with the second gateway device. The reference to the PDU session information enables the telecommunications network (e.g. a session management system thereof) to trace the PDU session information, or part thereof, of the UE stored therein. The relevant PDU session information of the UE may then be nested into the first session management context of the first gateway device having the first established PDU session with the telecommunications network.

The first PDU session information and second PDU session information, or portions thereof, may be the same (e.g. when an SDF remains the same when the UE moves) or be different (e.g. an SDF has been dropped or a new SDF has been established when the UE is connected to the first gateway device or to the telecommunications network resp. the second gateway device).

This aspect of the disclosure enables continuity of the application of the PDU session information by transferring the PDU session information from one session management context to another session management context using the reference from the UE.

It should be appreciated that the first and/or second gateway device may be a 5G-residential gateway (RG) device providing a local network with non-3GPP wireless access, e.g. a WiFi network, but also providing a local network with 3GPP wireless access, e.g. Proximity Services, or other local area network wireless access technologies. The first and/or second gateway devices may be replaced by any device that is capable of having an established PDU session for plurality of UEs with a telecommunications network, such as a 5GC. The first and/or second gateway devices may comprise evolved 5G-RG devices and/or devices with PIN gateway capabilities.

It should also be appreciated that establishing or modifying a session management context may include initiating, adapting or removing data flows, such as a service dataflow (SDF) and/or a quality of service (QoS) flow from a PDU Session. The PDU session information may include one or more of this information, e.g. one or more SDFs and/or one or more QoS flows as mentioned above.

A data flow generally relates to a flow of data packets that may have a set of common characteristics. These characteristics can be described in a traffic filter, which can be a parameter tuple, a traffic flow template (TFT), packet detection rule, or anything alike.

In a 5G telecommunications network, an SDF describes a particular flow of packets having a set of common characteristics defined by a traffic filter which can be a parameter tuple, such as a 5-tuple (IP source address, IP destination address, port source address, port destination address and protocol type) or a 3-tuple (IP source address, IP destination address, port destination address). In 5G, one or more SDFs can be contained in the same QoS flow when the same policy and charging rules apply.

A reference to PDU session information includes anything that allows tracing this information or part thereof in a session management context in the telecommunications network, including an identifier of such information. Tracing based on the reference may be assisted by using other information, such as an address used for the UE in the second established PDU session. The address, e.g. the IP address, may be the same for the first and second PDU session.

References may be more general, such as a reference to a device associated with the context or a more specific reference referring to particular information in a session management context. The reference may, for example, comprise or consist of at least an identifier of the first gateway device (e.g. a 5G-RG ID) to include in the PDU session modification request or an identifier of the further device (e.g. a UE ID or 5G-RG ID of the second gateway device). The reference may further include one or more PDU Session IDs, one or more, e.g. a list, of SDFs and the IP address that the UE uses in the local network. Other alternatives for a reference are also possible.

In one embodiment, the UE may be configured to determine availability of the local network and, possibly, to transmit the PDU session modification request when the local network is unavailable and, possibly, the access request or other request when the local network is available. The UE may e.g. determine a signal level from the local network and use this level to determine if or when to transmit the PDU session modification request to the telecommunications network or the access request or other request to the first gateway device, e.g. by comparing the signal level with a signal level threshold. This embodiment facilitates control by the UE of the connection continuity.

In one embodiment, the UE may be configured to receive the at least one reference to the first PDU session information in a message from the gateway device. The reference may be received, for example, during connection establishment with the first gateway device or during allocation of an address to the UE by the first gateway device. The reference may e.g. be obtained in a WiFi network via an Association Response message. Another embodiment involves that the UE may receive the reference during the IP address allocation which may e.g. be conducted with DHCP (or host booting protocols, i.e. Neighbor Discovery Protocol [RFC1122] with ICMPv6) after the association process on layer 2 is complete. This decouples obtaining the reference from the access type since DHCP can be used over different lower layer medium access technologies. The reference may, for example, be included in the Option field of a DHCP message [RFC2939] or ICMPv6 Router Advertisement message or in any other field.

Similarly, if the further device is, for example, a second gateway device, the reference may be received in a message from the second gateway device as defined above for the first gateway device.

In one embodiment, the UE is configured for at least one of the following:
to receive an authentication token from the first gateway device or second gateway device and to transmit the authentication token with the PDU session modification request to the telecommunications network resp. with the access request to a gateway device, such as the first gateway device;
to receive an authentication token from the first gateway device and the telecommunications network and determine authentication for each of the received tokens separately or in combination.
   The embodiment enables verifying authentication for the UE to transfer the PDU session information, or part thereof, associated with the UE when it moves between the local network(s) or between the local network and the telecommunications network.

In one embodiment, the UE is configured to include the reference identifying the second PDU session information in an Association Request, an ICMPv6 Router Solicitation, a DHCP Discover request or a DHCP Request request to the first gateway device.

Other embodiments of the disclosure involve methods in the UE for maintaining PDU session continuity. The method may be performed by running software containing software code portions that, when executed, perform one or more steps of the method.

In one aspect, a method in a UE is disclosed in a system comprising a first gateway device having a first established packet data unit, PDU, session with a telecommunications network storing a first session management context for the first gateway device associated with the first established PDU session and providing a local network for a plurality of UEs using the first established PDU session of the first gateway device. The system may also comprise a further device, e.g. the UE itself or a second gateway device, having a second established PDU session with the telecommunications network storing a second session management context associated with the second established PDU session.

The method may involve transmission by the UE of at least one of a PDU session modification request to the telecommunications network and an access request to the first gateway device. The PDU session modification request may comprise a reference to first PDU session information, or part thereof, in the first session management context stored in the telecommunications network for the UE to include at least part of the first PDU session information in the second session management context. The access request may comprise a reference to second PDU session information, or part thereof, in the second session management context stored in the telecommunications network to include at least part of the second PDU session information in the first session management context.

Other aspects of the disclosure involve methods executed by the UE to operate as specified in one or more of the embodiments of the UE above, including the embodiments of claims 2-6.

The telecommunications network may be a 3GPP 5G network including a radio access network and/or fixed access network and a 5G core (5GC) network as standardized in 3GPP. In such telecommunications networks, network functions may be defined which typically involve a set of software running on a system (e.g. a cloud platform) rather than an integrated product with dedicated hardware. Hence, in the present disclosure, reference will be made to systems that perform a particular function, e.g. a session management system performing a session management function (SMF).

Other aspects of the present disclosure involve the session management system in the telecommunications network and the gateway device and methods therefore.

The session management system may have direct or indirect access to a session management context stored in the telecommunications network.

One aspect of the disclosure pertains to a session management system in a telecommunications network storing a first session management context associated with a first established PDU session for a first gateway device providing a local network for a plurality of UEs to enable data exchange with a data network over the telecommunications network using the first established PDU session, and storing a second session management context associated with a second established PDU session for a further device (for example a UE or a second gateway device). The session management system is configured for at least one of the following:
receiving a PDU session modification request from the further device to modify the second established PDU session, wherein the PDU session modification request contains a reference to first PDU session information in the first session management context, and wherein the session management system is further configured for tracing the first PDU session information based on (e.g. assisted by) the reference and to include at least part of the first PDU session information in the second session management context;
receiving a PDU session modification request from the first gateway device to modify the first established PDU session, wherein the PDU session modification request contains a reference to second PDU session information in the second session management context, and wherein the session management system is further configured for tracing the second PDU session information based on (e.g. assisted by) the reference and to include at least part of the second PDU session information in the first session management context.
   This enables the session management system to provide connection continuity, e.g. service data flow continuity, for the UE when the UE moves out of or into the local network of the first gateway device. Another problem in the prior art is that it is the 5G-RG that assigns addresses, e.g. IP addresses, to UEs rather than the 5GC. The local network is usually a separate administrative domain and decision-making in this domain is decoupled from the 5GC. Since many features of the network are based on the UE's IP address and its binding to a PDU Session, the movement of sessions with PDU type IP or IPv6 where IP addresses are not allocated and verified by the telecommunications network is currently not supported. Hence, in one embodiment, the session management system may be configured to receive an address for a UE from the first gateway device and to assign the address to the UE for the second established PDU session. This embodiment enables keeping the addresses, e.g. IP addresses, the same in the local network and in the telecommunications network so that service data flows can remain the same for the first and second established PDU sessions whenever the first or second PDU session of a UE or second gateway device is established. For example, when the UE or second gateway device issues a PDU session establishment request, the session management system may request an address from the first gateway device, for example identified based on the DNN for which the request is made, and receive the address accordingly and assign the address to the UE in the PDU session establishment accept message. Other ways to assign the address by the first gateway device include to assign the first gateway device as an external DHCP server for the DNN.

In one embodiment, the session management system is configured to execute at least one of:
performing a PDU session modification procedure to modify the first established PDU session of the first gateway device during or after modifying the second established PDU session by removing the first PDU session information, or part thereof, included in the second session management context from the first session management context; and
performing a PDU session modification procedure to modify the second established PDU session of the further device (e.g. the UE or the second gateway device) during or after modifying the first established PDU session by removing the second PDU session information, or part thereof, included in the first session management context from second session management context.
   These embodiments facilitate updating the respective session management contexts during or after the UE moving to another network.

Furthermore, the session management system may be configured to add at least one forwarding rule in the telecommunications network corresponding to the modified first resp. second PDU session and/or to update the access network of the telecommunications network. These embodiments facilitate setting of the telecommunications networks in accordance with the changed session management contexts, e.g. in the system performing a user plane function (UPF) to route data for the UE to the first or second established PDU session. As another example, the session management system may also update the access part of the telecommunications network to remove any existing QoS flows that the UE's SDFs were using and are not being used by other UE's SDFs anymore.

In one embodiment, the session management system may be configured for at least one of:
to receive an authentication token from the UE in a modification request for the second PDU session and to transmit the authentication token to the first gateway device or an authentication system in the telecommunications network for authentication of the UE;
to receive an authentication token from the UE in a modification request for the second PDU session and to receive the authentication token from the first gateway device to authenticate the UE.
   The embodiments enable the session management system to verify in conjunction with the gateway device authentication of the UE if or when requesting continuity of the connection. Authentication verification may be conducted in the gateway device, in the session management system or in both.

In one embodiment, the session management system contains a first session management entity having access to the first session management context and a second session management entity having access to the second session management context, wherein the first resp. second session management entity is configured to request information from a repository to identify the second resp. first session management entity storing the second resp. first session management context based on (e.g. assisted by) the reference. The embodiment facilitates retrieving PDU session information from the first and second session management contexts when these are located at different places in the network, e.g. in different SMFs.

In one embodiment, the session management system is configured for at least one of:
receiving and storing an indication from the first gateway device in a PDU session establishment request for establishing the first established PDU session of the first gateway device, the indication indicating that the first gateway device is available for assigning addresses to UEs;
requesting an address for a further device (e.g. the UE or the second gateway device) from the first gateway device in response to receiving a PDU session establishment request from the further device for the second established PDU session and receiving the address from the first gateway device;
allocating an address assigned by the first gateway device to the further device in a PDU session establishment accept message to the further device;
receiving an indication from the first gateway device in a PDU session establishment request for establishing the first established PDU session of the first gateway device, the indication indicating that the first gateway device is available for assigning addresses to UEs and distributing the indication to a plurality of entities of the session management system associated with a data network indicated in the PDU session establishment request.
   In this embodiment, the session management system is made aware of the availability of the first gateway device for address allocation or is instructed that addresses should be obtained from the first gateway device. The embodiment facilitates allocation of the same address in the local network and in the telecommunications network for the UE. Use of the same address, such as an IP address, may assist in tracing the session information and/or facilitates the transfer from one PDU session to another PDU session. Measures may be taken that the indication, or a derivative thereof, is stored in several entities of the session management system. In one embodiment, these entities may be associated with the data network name (DNN) provided with a PDU session establishment request to the session management system.

Other embodiments of the disclosure involve methods in the session management system for maintaining connection continuity. The method may be performed by running software containing software code portions that, when executed, perform one or more steps of the method.

In one aspect, a method in a session management system is disclosed. The session management system may have direct or indirect access to first and second session management contexts stored in the telecommunications network. The session management system may store a first session management context associated with a first established PDU session for a first gateway device providing a local network for a plurality of UEs to enable data exchange with a data network over the telecommunications network using the first established PDU session, and may store a second session management context associated with a second established PDU session for a further device (e.g. a UE or a second gateway device). The method in the session management system may include the step of receiving a PDU session modification request from the further device. The PDU session modification request may contain a reference to first PDU session information in the first session management context, and the session management system may then trace the first PDU session information based on (e.g. assisted by) the reference and include at least part of the first PDU session information in the second session management context. The method may also include the step of receiving a PDU session modification request from the first gateway device. In that case the PDU session modification request contains a reference to second PDU session information in the second session management context, and the session management system traces the second PDU session information based on (e.g. assisted by) the reference and includes at least part of the second PDU session information in the first session management context.

Other aspects of the disclosure involve methods executed by the session management system to operate as specified in the embodiments of the session management system above, including the embodiments of claims 8-12.

One aspect of the disclosure pertains to a device, e.g. a gateway device, configured to provide a local network for a plurality of UEs and to provide a first established PDU session with a telecommunications network for data communication with a data network over the telecommunications network for the plurality of UEs. The device is configured for at least one of the following:
transmit a reference to first PDU session information in a first session management context stored in the telecommunications network associated with the first established PDU session to at least one of the plurality of UEs over the local network. The UE can use this reference in the PDU session modification request to the telecommunications network to allow connection continuity when the UE disconnects or moves out of the local network;
receive a reference to second PDU session information in a second session management context associated with a second established PDU session of a further device (the UE itself or a second gateway device) from a UE and transmit a PDU session modification request including the reference over the telecommunications network to include at least part of the second PDU session information in the first session management context of the first gateway device.

Again, in this manner, the device supports connection continuity for a UE moving into or out of the local network provided by the gateway device.

In one embodiment, the gateway device is configured for transmitting an indication to a session management system, the indication indicating that the gateway device is available for assigning addresses to UEs. In one further embodiment, the gateway device is configured to receive a request from a session management system for an address for a UE and to provide the address to the session management system for the UE, wherein the provided address corresponds to an address allocated or to be allocated in the local network of the gateway device. In one embodiment, the gateway device is configured to allocate an address to a UE in a local network provided by the gateway device, wherein the allocated address corresponds to the address provided to the session management system. These embodiments facilitate using the same address in the local network and in the telecommunications network and/or vice versa. Use of the same address, such as an IP address, may assist in tracing the session information and/or transfer from one PDU session to another PDU session.

In one embodiment, address control by the gateway device can be combined with authenticating a UE for connection continuity. The gateway device may be configured to transmit an authentication token to a UE corresponding to an authentication token stored in the telecommunications system, for example in the session management system or in an authentication system, when the UE is connected to the local network. In one embodiment, authentication of the UE is performed when receiving the request for an address, including the token, from the session management system at the gateway device and providing the address or a verification result to the session management system in response.

Other embodiments of the disclosure involve methods in the gateway device for maintaining connection continuity. The method may be performed by running software containing software code portions that, when executed, perform one or more steps of the method.

In one aspect, a method in a gateway device is disclosed. The gateway device is configured to provide a local network for a plurality of UEs and to provide a first established PDU session with a telecommunications network for data communication with a data network over the telecommunications network for the plurality of UEs. In one embodiment, the method involves transmitting a reference to first PDU session information in a first session management context stored in the telecommunications network associated with the first established PDU session to at least one of the plurality of UEs over the local network. The UE can use this reference in the PDU session modification request to the telecommunications network to allow connection continuity when the UE disconnects or moves out of the local network. The method may also involve the step of receiving a reference to second PDU session information in a second session management context associated with a second established PDU session of a further device (the UE itself or a second gateway device) from a UE and transmit a PDU session modification request including the reference over the telecommunications network to include at least part of the second PDU session information in the first session management context of the first gateway device.

Other aspects of the disclosure involve methods executed by the gateway device to operate as specified in one or more of the embodiments of the gateway device above, including the embodiments of claim 14.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the person's computer, partly on the person's computer, as a stand-alone software package, partly on the person's computer and partly on a remote computer, or entirely on the remote computer or server. In the latter scenario, the remote computer may be connected to the person's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1A is a schematic illustration of a 5G network architecture according to the prior art;

FIG. 1B is a schematic illustration of a 5G Core network (5GC) according to the prior art;

FIG. 1C is a schematic illustration of a PDU session establishment request in a 5G network according to the prior art;

FIG. 1D is a schematic illustration of a PDU session modification request in a 5G network according to the prior art;

FIG. 2A is a schematic illustration of a local network comprising a 5G Residential Gateway providing wireless coverage for a plurality of UEs connected to a 5GC via either wireline or wireless connections according to an embodiment of the invention;

FIG. 2B is a schematic illustration of a UE moving between a local network and a telecommunications network;

FIG. 2C is a schematic illustration of a UE moving between a local network and a further local network;

FIG. 3 is a schematic illustration of some steps of a service flow mobility procedure from a local network of a gateway device to a 5G telecommunications network according to an embodiment of the invention;

FIG. 4 is a schematic illustration of some steps of a service flow mobility procedure from a 5G telecommunications network to a local network of a gateway device according to an embodiment of the invention;

FIG. 5 is a schematic illustration of some steps of a service flow mobility procedure from a second gateway device providing a further local network for a plurality of UEs to a first gateway device providing a local network for a plurality of UEs according to an embodiment of the invention;

FIG. 6A is a schematic illustration of some step of address assignment by a telecommunications network to a UE if the UE and first gateway device are served by the same session management entity;

FIG. 6B is a schematic illustration of some step of address assignment by a telecommunications network to a UE if the UE and first gateway device are served by the different session management entities; and

FIG. 7 depicts a processing system according to an embodiment for a processing device or a server system.

### DETAILED DESCRIPTION OF THE DRAWINGS

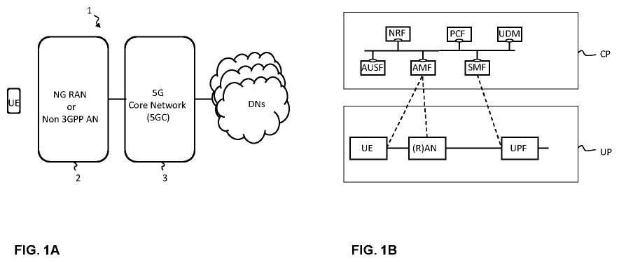

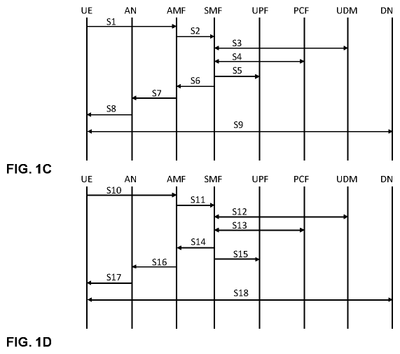

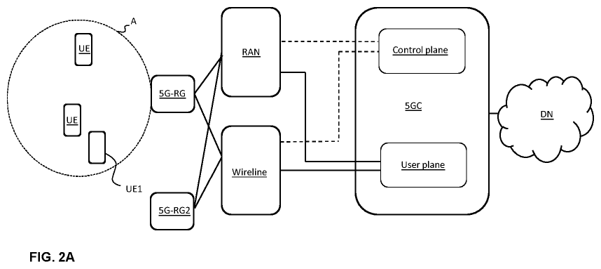

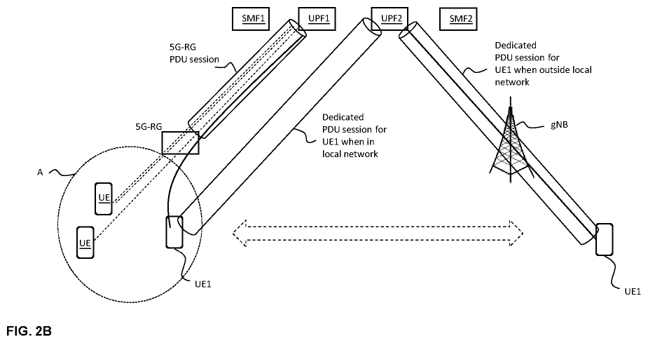

FIG. 1A is a schematic illustration of a 5G network architecture 1 according to the prior art. The 5G network is composed of a 5G access network 2 and a 5G core network (5GC) 3. The access network is made up of a new-generation radio access network (NG-RAN) which uses the 5G new radio interface (NR). The NG-RAN comprises 5G base stations, referred to as gNB's (not shown) which are connected to the 5GC and may be connected to each other. The access network 2 also comprises a non-3GPP access network (e.g. WiFi, xDSL, etc) connecting to the 5GC. The different network entities are connected by an underlying TCP/IP transport network. The 5G network architecture is connected to a plurality of data networks DN. Data networks can be the internet, an operator specific network, a dedicated network, etc.

FIG. 1B shows a 5GC in a service-based architecture in combination with a UE and access network (R)AN. The 5GC comprises many systems that are defined in terms of network functions (NF) that provide services as sets of interactions between two or more network functions. The upper part of FIG. 1B shows a set of network functions that form the 5G control plane CP. Amongst others, the control plane comprises an access and mobility management function (AMF) that handles most signalling coming from and going to the UE. The AMF also interacts with other functions in the control plane. The AMF does not handle session management but forwards session-related messages to and from a system performing a session management function (SMF), hereinafter referred to as session management system. The SMF performs establishment, modification and release of PDU sessions. The control plane may also comprise a system performing a policy control function (PCF) that provides policy rules (QoS, filtering, charging) to other control plane functions, such as the SMF. The 5G Policy Architecture is defined in more detail in 3GPP TS 23.503. Further functions that are comprised in the control plane include the unified data management function (UDM), the authentication server function (AUSF), and the network repository function (NRF). The UDM is partly equivalent of the home server system HSS in 3G and 4G networks and is a repository for UE-related information, such as credentials, identifiers, AMF details, and SMF PDU sessions. The AUSF supports authentication for 3GPP and non-3GPP access. The network function may query the network repository function (NRF) to discover and enable communication with another network function. When the NRF receives a discovery request from an instance of a network function, it provides the discovered instances of the network function, e.g. the instances of the SMF.

For the user plane UP, the lower part in FIG. 1B, the UE communicates via the access network 2 with a system performing a user plane function (UPF). Data is tunnelled between the access network and the UPF, sometimes referred to as the NG-U tunnel. The main task of the UPF is to process and forward user data. The UPF is controlled by the SMF and connects with external data networks DN.

The system performing the session management function SMF has the responsibility for setting up connectivity for the UE toward data networks as well as managing the user plane for that connectivity. In order to connect to a DN, the UE requests establishment of a packet data unit (PDU) Session. The PDU is the basic end-user protocol type carried by the PDU session, e.g. IP packets or Ethernet frames. Each PDU session provides an association between the UE and a specific DN.

FIG. 1C provides a simplified PDU Session Establishment procedure as set out in more detail in 3GPP TS 23.502, v16.3.0.

In step S1, the UE transmits a PDU Session Establishment Request after the UE is registered with the 5GC sending a registration request to the AMF. The PDU Session Establishment Request is transmitted as a session management container in a NAS message to the AMF. The PDU Session Establishment Request contains the PDU session ID, the Requested PDU Session Type, and, possibly, a data network name (DNN). The PDU Session ID is a unique identifier generated by the UE that is different for different PDU sessions. The Request Type indicates “Initial Request” if the PDU Session Establishment is a request to establish a new PDU session and indicates “Existing PDU Session” if the PDU Session Establishment Request refers to an existing PDU session between 3GPP access and non-3GPP access or to a PDU Session handover from an existing PDN connection in a 4G EPC. When the access network receives the PDU Session Establishment Request, the NAS message is encapsulated in an N2 message towards the AMF.

The AMF selects an SMF as described in TS 23.501 and may either use a DNN provided by the UE or select a (default) DNN using e.g. subscription information from UDM. Based on the Request Type, the AMF determines whether the PDU Session Establishment request relates to an existing PDU session or to a new PDU session. In step S2, the AMF sends a message Nsmf_PDUSession_CreateSMContext Request to the SMF containing the PDU Session Establishment Request, DNN information, a PCF ID, etc. when the AMF is not already associated with an SMF. Else, the AMF sends_PDUSession_UpdateSMContextRequest to the SMF. If the Request Type indicates “Existing PDU Session”, the SMF determines that the request is due to switching between 3GPP access and non-3GPP access. The SMF may then identify the existing PDU Session based on the PDU Session ID. In such a case, the SMF does not create a new SM context but instead updates the existing SM context

The SMF may also interact with the UDM and PCF based on the data provided by the UE as can be observed from steps S3 and S4 to obtain subscription data and policy rules.

In step S5, the SMF interacts with the UPF to establish a session for the user plane. The SMF sends an N4 Session Establishment Request to the selected UPF and provides packet detection, enforcement, forwarding and reporting rules to be installed on the UPF for this PDU Session if the Request Type is “Initial Request”. Otherwise, the SMF sends an N4 Session Modification Request. The UPF acknowledges the respective request with an N4 Session Establishment/Modification Response. In this procedure, the SMF obtains tunnel information from the UPF.

In step S6, the SMF interacts with the AMF. Following the successful creation of a tunnel end point, the SMF sends Namf_Communication_N1N2MessageTransfer with tunnel information for N2 message and PDU session details in N1 Container and provide the representation of the SM context or updated SM context to the AMF.

In step S7, the AMF sends a N2 PDU Session Setup Request to the appropriate gNB of the access network AN along with N2 session management parameters received from SMF as QFIs, QoS Profile. The transmission from the AMF to the access network AN also includes the NAS message destined to the UE, including session parameters like QoS Rules and UE IP address.

The gNB establishes the tunnel based on the information received from the AMF and sets up a tunnel end point and forwards information to the UE for setting up a PDU session in step S8. The gNB also reports back to the AMF that subsequently informs the SMF about the successful setup of the tunnel.

After this step, the tunnel is established and the PDU session exists between the UE and the UPF allowing data transfer with the DN, indicated by step S9.

When an established PDU session already exists, as is the case for most embodiments in the present disclosure, the established PDU session may be modified using a PDU Session Modification procedure. Some steps of a prior art PDU Session Modification procedure are illustrated schematically in FIG. 1D. More detailed information is provided in 3GPP TS 23.502, v16.3.0, clause 4.3.3.2.

In step S10, the UE initiates the PDU Session Modification procedure by the transmission of a NAS message containing a PDU Session Modification Request. The PDU Session Modification Request contains, amongst others, the PDU session ID indicating the PDU session to be modified. When the UE requests specific QoS handling for selected SDFs, the PDU Session Modification Request includes Packet Filters describing the SDFs and the requested operation (add, modify, delete) on the indicated Packet Filters. The PDU Session Modification Request may also contain a requested QoS. The NAS message containing the PDU Session Modification Request is forwarded by the (R)AN to the AMF.

In step S11, the AMF transmits a message to the SMF by invoking Nsmf_PDUSession_UpdateSMContext to update the session management context of the UE in the session management system. Upon receipt of the message, the SMF starts the PDU session modification.

Steps S12 and S13 show the SMF communicating with the UDM resp. PCF to update subscription data and report subscribed events if needed. The SMF may apply local policies as well.

In step S14, the SMF responds to the AMF with a message comprising N2 SM information for the AMF and an N1 SM container for the UE. The N2 SM information carries the information that AMF must provide to (R)AN. It can include a QoS configuration file and corresponding QFI to notify (R)AN that one or more QoS flows have been added or modified. The N1 SM container carries the PDU session modification command that the AMF must provide to the UE. It may include QoS rules, QoS flow-level QoS parameters required by QoS flows associated with QoS rules, and corresponding QoS rule operations and QoS flow-level QoS parameter operations to notify the UE that one or more QoS rules have been added or deleted or modified.

In step S15, the SMF updates the UPF(s) that are involved by the PDU Session Modification by sending N4 Session Modification Request message(s) to the UPF. For example, the SMF may add, change or remove packet detection rules and/or forwarding rules or parts thereof at the UPF.

In step S16, the AMF sends a N2 PDU Session Resource Modification Request to the appropriate gNB of the access network AN along with N2 session management parameters received from SMF that changed as part of the modification procedure, i.e SDFs, QoS flows. The transmission from the AMF to the access network AN also includes the NAS message PDU Session Modification Command destined to the UE as a response to the PDU Session Modification Request in S10, including any session management parameters that are allowed by the network to change.

The gNB modifies the UE PDU Session Resource accordingly and also propagates any change to the UE on the access network level in S17 if applicable.

After this step, the tunnel illustrated by step S18 may be modified between the UE and the DN.

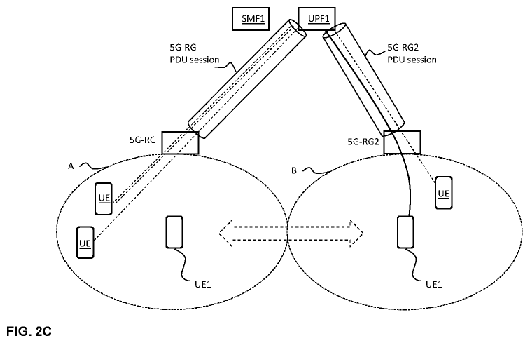

FIG. 2A is a schematic illustration of a local network comprising a gateway device, such as a 5G Residential Gateway (5G-RG), providing wireless coverage in an area A for a plurality of UEs connected to a 5GC via either a wireline access network or a wireless access network containing gNBs. The 5G-RG may connect or have connected to the 5GC as a UE in a manner corresponding to FIG. 1C interacting with functions in the control plane and user plane and forwards traffic to and from the UEs in the local network via the PDU session. The 5G-RG may assign addresses, e.g. IP addresses or MAC addresses, to UEs in the local network. In this manner, the UEs behind the 5G-RG can make use of a single PDU session of the 5G-RG for a data network DN without being registered in the 5GC and using the IP address assigned by the telecommunications network to the 5G-RG.

With framed routing, a range of IP addresses or IPv6 prefixes are reachable over a single PDU session. The UEs have IP addresses within the IP address range of the framed route. Also, the UPF has forwarding rules (based on the framed route) enabling traffic routing for subnets behind the 5G-RG in the 5G-RG PDU session.

One or more of the UEs under the wireless coverage of the 5G-RG may move out of the area A of the 5G-RG or disconnect from the 5G-RG. In one embodiment, a UE may be configured to determine availability of the local network provided by the 5G-RG. In one embodiment, the UE may e.g. determine a signal level from the local network provided by the 5G-RG. If the UE determines that the local network is unavailable, it may perform one or more actions disclosed below.

When the local network of the 5G-RG is no longer available, UE1 detecting this situation can no longer make use of the PDU session of the 5G-RG. UE1 may, however, also have an established PDU session for itself or may want to make use of a PDU session of another gateway device 5G-RG2. 5G-RG2 may provide a further local network potentially serving further UEs (not shown).

The below disclosure describes one embodiment for maintaining service flow continuity for the UE1 while the PDU session of the 5G-RG is maintained for serving the UE(s) remaining in the local network and the PDU session of UE1 or 5G-RG2 are also maintained.

When a UE is in the local network coverage of 5G-RG, it requests connectivity from the 5G-RG. Depending on the access technology used by the 5G-RG in the local network, different connectivity establishment procedures can be used. In the case of WiFi access, this is the authentication and association process between a UE and a WiFi access point. In the association process with the 5G-RG, the UE may receive a reference to PDU session information, described in further detail below, in the Association Response message from the 5G-RG. Another embodiment entails that the UE receives the reference to PDU session information during the address assignment which is usually done with DHCP (or host booting protocols, i.e. Neighbor Discovery Protocol [RFC1122] with ICMPv6) after the association process on layer 2 is complete. This may decouple obtaining the reference to PDU session information from the access type since DHCP can be used over different lower layer medium access technologies. The reference to PDU session information may e.g. be included in the Option field of a DHCP message [RFC2939] or ICMPv6 Router Advertisement message.

The reference to PDU session information that the UE uses may be provided by the 5G-RG when UE gets access to the gateway device as described above, and may be appropriately updated if the reference changes during the UEs connectivity to the gateway device. In one embodiment, the reference to the session information comprises an identifier to the 5G-RG, such as a 5G-RG ID or any other identifier that is configured in the system to assist in identifying the session information in the telecommunications network. Other information obtained during the access procedure with the 5G-RG may include at least one of a 5G-RG PDU Session ID, a list of SDFs and QoS flow IDs and the IP address that the UE uses in the local network (and may be the same as for the established PDU session for the UE itself) as may be used, inter alia, to construct a more specific identifier.

When the UE is associated with/connected to the 5G-RG, all types of traffic may be routed via the 5G-RG PDU Session towards the data network DN via a 5G-RAN or via wireline access and the 5GC as shown in FIG. 2A. In one other embodiment, the 5G-RG is an Internet Gateway for the UE. In case QoS is configured in the 5G-RG, the 5G-RG may map SDFs with certain QoS from the UE to appropriate QoS flows in the PDU Session of the 5G-RG via the 5GC. These SDFs can be established with the UE's IP address, rather than the 5G-RG IP address.

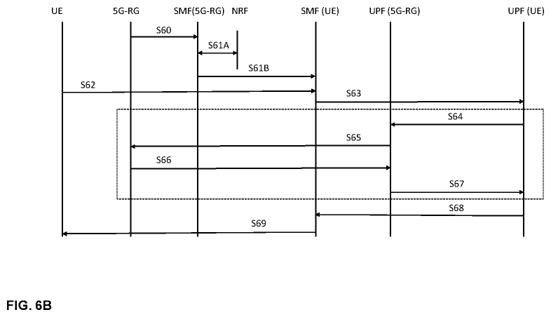

In one embodiment, the UE is configured to be allocated an address, such as an IP address, by the gateway device, such as the 5G-RG, and use this same address for the PDU session it has itself with the telecommunications network as will be described in further detail below with reference to FIGS. 6A and 6B.

FIGS. 2B and 2C are schematic illustrations of a UE, UE1, moving between a local network provided by the 5G-RG in coverage area A and a telecommunications network presented by the gNB of a 5G RAN in FIG. 2B and a further 5G-RG2 having coverage area B in FIG. 2C.

UEs in the coverage areas A and B benefit from the 5G-RG PDU sessions existing between the 5G-RG and 5G-RG2 and the UPF1 anchor for the 5G-RG or 5G-RG2 of the 5GC, presented as a pipe in FIG. 2B, containing several SDFs/QoS flows indicated by the dashed lines within the pipe. UE1 uses such PDU session for its SDF/QoS flow, indicated by the solid line within the pipe, as discussed above. The session management context for the 5G-RG PDU session may be stored in a session management entity of the session management system, denoted as SMF1 in FIG. 2B.

In addition, in FIG. 2B, UE1 may also have a dedicated PDU session with the telecommunications network, also presented as a pipe in FIG. 2B. The PDU session may be empty (no solid or dashed lines have been drawn with this pipe), meaning that the PDU session does not contain any service data flow SDF and/or QoS flow. Still, the PDU session of the UE1 in FIG. 2B is already established in order to facilitate data flow mobility for UE1. UPF2 anchor and SMF2 deal with the dedicated PDU session of UE1 in FIG. 2B.

When UE1 moves out of the coverage area A of the 5G-RG in FIG. 2B, indicated by the dashed double arrow, the dedicated PDU session of UE1 is modified using the reference to the session information in SMF1 regarding e.g. an SDF of UE1, so that the dedicated PDU session can make use of the existing session information for UE1 in SMF1 when UE1 was still served by the 5G-RG in order to obtain flow continuity. Hence, the SDF/QoS flow information is branched out of the 5G-RG PDU session management context in SMF1 and included in the session management context for the already existing dedicated PDU session. This information is stored in the 5GC, e.g. in SMF2. The 5G-RG PDU session is maintained.

Reversely, when UE1 moves back into coverage area A of the 5G-RG in FIG. 2B, again indicated by the dashed double arrow, UE1 wants to make use of the 5G-RG PDU session. UE1 sends a reference to its own session information for the dedicated PDU session as stored in the telecommunications network to the 5G-RG, for example in an access request to the 5G-RG in order to enable the 5G-RG to interact with the telecommunications network, e.g. with the SMF entity SMF2 via SMF1 of the 5G-RG, to nest the data flow of UE1 into the session management context of the PDU session of the 5G-RG in SMF1. For this purpose, the 5G-RG initiates a PDU session modification request to the telecommunications network. In particular, the 5G-RG transmits the reference to the session management system with the session modification request.

In the above embodiment, UE1 may have the same IP address behind the 5G-RG and when connected to the telecommunications network. The 5G-RG has a different IP address, but this is irrelevant for the service data flow of the UE because the 5G-RG acts as a router.

In FIG. 2C, UE1 originally used the established PDU session of the 5G-RG2. Both the PDU session of the 5G-RG and of the 5G-RG2 use a common session management system SMF1 for storing the respective session management contexts. When UE1 moves out of coverage area B and/or disconnects from the 5G-RG2, it may want to make use of the established PDU session of the 5G-RG by sending an access request to the 5G-RG. The process is similar to the one in the previous paragraph.

The SDFs may remain the same between the two PDU sessions which implies that the same IP address is used in both PDU sessions. In one embodiment, this can be achieved such that whenever the PDU session of the UE1 was established, the 5G-RG is used to allocate an IP address for the UE and keep the same allocation during UE movements. One embodiment includes that the 5G-RG is configured as an external DHCP server and another is using NAS-SM signaling between the 5G-RG and session management system whenever the PDU Session of the UE1 is created. Whenever the flows are moved between the two PDU Sessions, the session management system comprising SMF1 and SMF2 also changes the forwarding rules in both UPF anchors.

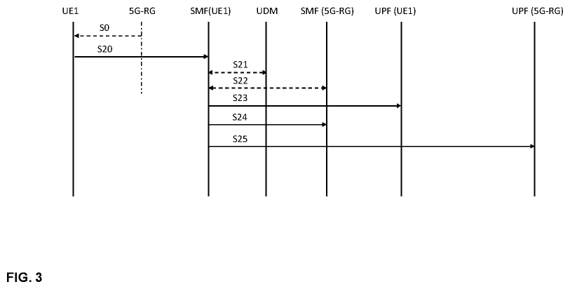

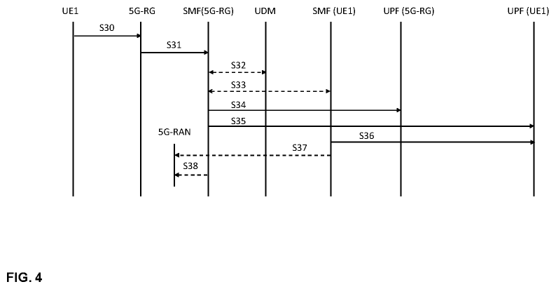

FIGS. 3 and 4 are schematic illustrations of examples of some steps in flow mobility procedures performed by the UE, the gateway device and the SMF system when UE1 is moving out of the local network resp. moving (back) into the local network provided by the 5G-RG as schematically illustrated in FIG. 2B.

In general, the solution entails moving one or more SDFs from the 5G-RG PDU session to the UE PDU Session (at the request of the UE) when its moving out of the local network using the 5G-RG PDU Session information, and “nesting” the one or more SDFs from the PDU Session of the UE into the one of the 5G-RG when the UE is moving back into the home network. In order for the 5GC (more specifically the SMF) to be able to use the PDU session information including one or more active SDFs and/or QoS flows of the 5G-RG, the UE may transmit a reference to this PDU session information when it initiates mobility from the local network to the 5GC. The reference is provided to the SMF during a PDU session modification procedure, upon which the SMF will find the 5G-RG PDU Session Information, move the one or more SDFs of the UE to the dedicated UE PDU Session and remove SDFs of the UE from the 5G-RG PDU Session.

The reference that the UE uses is provided by the 5G-RG to the UE before the UE initiates mobility, and is appropriately updated if it changes during the UEs connectivity via the 5G-RG. It may comprise at least of a 5G-RG ID or UE ID, but may include PDU Session IDs, list of SDFs and the IP address that the UE uses in the local network. Other alternatives for a reference are possible, described in the technical description of the solution.

Together with the reference, also an authorization token, username/password, certificate or similar may be provided to the UE, such that the UE can show that indeed it is authorized to move the SDFs out of the PDU session to the 5G-RG.

The below description addresses some aspects of these changes and illustrates these with reference to FIG. 3. It should be appreciated that the sequential order of the steps may be different and that further steps may be included before or after an indicated step in the procedure.

Step S0 precedes the PDU Session Modification procedure. In step S0, UE1 receives a reference to the PDU session information of the 5G-RG associated with the UE when accessing or being connected to the local network. The reference may e.g. be obtained in a WiFi network via an Association Response message. Another embodiment involves that the UE may receive the reference during the IP address allocation which may e.g. be conducted with DHCP (or host booting protocols, i.e. Neighbor Discovery Protocol [RFC1122] with ICMPv6) after the association process on layer 2 is complete. This decouples obtaining the reference from the access type since DHCP can be used over different lower layer medium access technologies. The reference may, for example, be included in the Option field of a DHCP message [RFC2939] or ICMPv6 Router Advertisement message or in any other field.

In step S20, when, for example, the wireless signal strength of the local network decreases below a certain threshold, the UE sends PDU Session Modification request to the SMF (via the AMF) in accordance with its own dedicated PDU session. The reference in this message contains at least the 5G-RG ID. Alternatively, the reference may also contain one or more of the 5G-RG PDU Session ID, a list of SDFs, QoS Flow IDs and the UE's IP address. This may, as a beneficial effect, decrease the search space in the SMF of the 5G-RG to find the flows that need to be moved. In step S20, the UE1 may also include the token to show that it is authorized to take SDFs from the 5G-RG.

Since the SMF has received a PDU Session Modification request containing a reference as disclosed herein, it may automatically get aware that one or more SDFs of the UE needs to be moved from the 5G-RG PDU Session to the UE PDU Session. However, both PDU Sessions are not necessarily handled by the same SMF as shown in FIG. 3. If this is the case, the SMF entity of the UE may query, step S21, the UDM for the other SMF entity that is serving the 5G-RG. If both PDU Sessions are handled by the same SMF entity, the procedure can continue from step S23.

In step S21, the SMF entity associated with the UE1 sends a request to the UDM for the SMF ID that is handling the PDU Session of the 5G-RG. It may do this by invoking the Nudm_SDM_Get service operation from the Nudm_SDM service and provides the 5G-RG ID, 5G-RG PDU Session ID and the DNN. This information is available in the UDM subscription data type “UE context in SMF data” because SMFs register themselves with the UDM whenever a PDU Session is created by a UE. The data type is specified in TS 23.502 Table 5.2.3.3.1-1: UE Subscription data types. The UDM returns the SMF ID serving the 5G-RG to the SMF.

The SMF (UE) may check with an AUSF (not shown in FIG. 3) if the token it has received is correct (token may contain 5G-RG info). If there is no token when there should be one, or an invalid token, the procedure would end.

After the SMF of the UE has received the identity of the SMF of the 5G-RG, the SMF sends a request to the 5G-RG SMF in step S22 in order to obtain PDU Session information of the 5G-RG PDU Session that is related to the UE. In this example, the minimum information the SMF of the UE sends is the 5G-RG ID, 5G-RG PDU Session ID and the UE IP address. Alternatively or in addition, the SMF entity of the 5G-RG may also provide one or more of the DNN, QoS flow IDs and SDF list that needs to be transferred to the dedicated PDU Session of the UE in order to narrow the search space in the 5G-RG SMF entity. The SMF entity of the UE may include the token it obtained from the UE in step S20 if the token was issued by the SMF entity of the 5G-RG. Based on the token, the 5G-RG SMF may confirm that the UE is authorized for the mobility procedure. If there is no token, or an invalid token, the procedure would end here. The requested information is returned to the SMF entity of the UE from the SMF entity of the 5G-RG containing one or more of the description of the SDFs, the specific QoS Flows carrying the SDFs and the IP address of the 5G-RG UPF anchor. It may also include the 5G-RG N4 interface context and RAN context for later steps or alternatives therefore.

In step S23, now having the information necessary to transfer the flows, the SMF entity of the UE invokes the change of rules in the UPF to include the SDFs and transport them in the specified QoS flows. This corresponds to step S15 from FIG. 1D and to step 8 from 3GPP TS 23.502, v16.3.0, clause 4.3.3.2 with the difference of adding a forwarding rule for the local network subnet towards the 5G-RG UPF anchor and a more specific forwarding rule with destination UE1 towards the UE1 PDU Session tunnel. This information is known to the SMF entity of the UE due to the fact its set as a DNN config parameter or it can be provided in step S22 with the PDU Session information.

After setting up the flows and forwarding in the UE PDU Session, the SMF entity also triggers a change in the PDU Session of the 5G-RG by sending, step S24, a PDU session modification request to the SMF entity of the 5G-RG containing one or more of the 5G-RG ID, PDU Session ID, UE IP address and UE UPF anchor IP address. Alternatively or in addition, this SMF entity may also add the SDF descriptions and QoS Flow IDs that need to be removed. This message triggers the standard PDU Session Modification Procedure for the 5G-RG PDU Session starting from step 1d in 3GPP TS 23.502, v16.3.0, clause 4.3.3.2. The change from the standard procedure is the next step which corresponds to step 8 there.

In step S25, the SMF entity of the 5G-RG requests the UPF of the 5G-RG, possibly via the SMF of the 5G-RG, to remove the QoS Flows and/or SDFs related to the UE and add more specific forwarding rules for traffic destined to the UE towards the UE UPF anchor. In case the 5G-RG N4 interface context was provided to the SMF entity of the UE in step S22, this step is initiated by the SMF entity of the UE.

The procedure completes with steps S14-S17 from FIG. 1D to update the changes towards the AN of both the UE and 5G-RG initiated from each SMF entity (not illustrated in FIG. 3).

In one embodiment, the SMF may perform authorization for the session mobility of the UE by verifying whether the UE identifier is in the list of allowed local networking devices for the 5G-RG PDU Session. This list may be part of the Session Management Subscription data that may have been fetched previously by the SMF from the UDM as mentioned above. Alternatively, the SMF may request for authorization from the 5G-RG including the address of the UE. This would allow for more dynamic authorization procedure and prevention of unauthorized access. The SMF may also verify if the address given by the UE corresponds to the subnet from the framed route(s) in the 5G-RG's PDU session.

FIG. 4 is a schematic illustration of an embodiment showing some aspects of a flow mobility procedure from the perspective of the UE, the 5G-RG and the SMF system in the 5GC.

When, for example, the wireless signal strength of the gateway device 5G-RG, raises above a certain threshold, depending on the access network type, UE1 sends in step S30 a request to access the 5G-RG, including a reference to PDU session information of the dedicated PDU session of the UE1. In particular, the UE1 sends a request to access it to the 5G-RG, including the reference that indicates to the 5G-RG that the UE1 is initiating a flow mobility procedure from the telecommunications network. This reference contains at least one of the UE ID (SUPI, 5G-TMSI, IMSI, etc.) and the UE PDU Session ID. It may also contain, alternatively or in addition, at least one of the QoS Flow IDs and the SDF list to be moved to the established PDU Session of the 5G-RG. This may decrease the search space in one or more functions later on in the procedure.

In one embodiment, the UE1 is configured to include the reference identifying the second PDU session information in an Association Request, an ICMPv6 Router Solicitation, a DHCP Discover request or a DHCP Request request to the 5G-RG.

In step S30, the UE1 may also include a token it has received from the 5G-RG. With this token the UE1 can prove that it has been authorized for mobility procedures to and from the 5G-RG. If the token is UE specific, the 5G-RG SMF, UE SMF, or AUSF can check that the UE ID that is requesting the procedure corresponds with the UE that obtained the token (making it difficult to use a token for UE1 for mobility with another UE).

In step S31, the 5G-RG initiates the PDU Session Modification procedure for modifying the SDFs and/or QoS flows, starting from step 1a (from TS 23.502, v16.3.0, clause 4.3.3.2) towards the SMF serving the 5G-RG and including the reference received from the UE in the previous step.

The SMF entity associated with the 5G-RG receives the PDU session modification request containing the mobility reference and may therefore become aware that one or more of the SDFs of the UE may be moved from the dedicated PDU Session of the UE to the 5G-RG PDU Session. However, as with FIG. 3, it may occur that the UE PDU Session is handled by a different SMF entity, in which case the 5G-RG SMF may query the UDM for the SMF that serves the UE in step S32. If the 5G-RG SMF would be handling both PDU Sessions and already has the UE PDU Session information needed to move the one or more UE SDFs, it may skip this step and continue from S34, without performing step S37 if performed at all. The 5G-RG SMF may check the token it received from the UE (if it assigned it itself) check it with the AUSF or alternatively forward it to the UE SMF entity for checking.

In step S32, the 5G-RG SMF entity sends a request to the UDM for the UE SMF ID, by invoking the Nudm_SDM_Get service operation from the Nudm_SDM service and providing the UE ID and UE PDU Session ID. The SMF ID of the UE SMF entity can be found in the UDM subscription data type “UE context in SMF data”, because SMFs register with the UDM for each PDU Session created by a UE. The data type is specified in TS 23.502 Table 5.2.3.3.1-1: UE Subscription data types. The UDM returns the SMF ID of the SMF entity serving the UE to the 5G-RG SMF entity.

When the 5G-RG SMF entity has obtained the UE SMF ID, it sends a request to the UE SMF entity for UE PDU Session information in step S33 for initiating the changes in the next steps. The message may include at least one of the UE ID and UE PDU Session ID. It may also provide the QoS flow IDs and SDF list that may be moved to the 5G-RG PDU session.

The SMF entity associated with the UE sends the requested information to the 5G-RG SMF entity, including at least one or more of the description of the SDFs and the specific QoS Flows carrying the SDFs. It may also include the UE N4 interface and RAN context for later steps or alternatives therefore.

With the information for transferring the flow(s), the 5G-RG SMF entity modifies the rules in the 5G-RG UPF in step S34 to include SDF(s) related to the UE, transport them in the specified QoS flows and remove the specific forwarding rule for traffic destined to the UE. This is part of step 8 from the procedure (TS 23.502, v16.3.0, clause 4.3.3.2).

After modifying the 5G-RG PDU Session, the 5G-RG SMF entity may also initiate the modification of the dedicated PDU Session of the UE by sending a request in step S35 to the UE SMF entity, possibly via the SMF entity of UE1, including, for example, the UE ID and UE PDU Session ID. It may also provide the QoS flow IDs and/or SDF list to be moved to the 5G-RG PDU session. The UE SMF entity then starts with step 1d from the PDU Session Modification procedure (TS 23.502, v16.3.0, clause 4.3.3.2). This modification may include removing the SDFs from the dedicated PDU Session of the UE and removing the forwarding rule in the UE UPF related to the UE. This is part of step 8 from the procedure. Alternatively, if the 5G-RG SMF has an N4 connection with the UE UPF anchor and the UE SMF N4 Interface context received in step S33, it may initiate the PDU Session Modification procedure directly towards the UE UPF, instead of via the UE SMF entity. In this case, the 5G-RG SMF entity performs the PDU Session modification procedure starting with step 1d of 3GPP TS 23.502, v16.3.0, as described therein. The 5G-RG SMF will also perform the next step (step S36) instead of the UE SMF.

In step S36, The UE SMF entity may request the UE UPF anchor to remove the QoS Flows and SDFs and remove the forwarding rules for traffic destined to the UE.

When the UE1 moves to the local network of the 5G-RG, the dedicated PDU Session of the UE may still be active, but empty. In such a case, the 5G-RAN is not used for the UE PDU Session anymore, because the radio access is covered by the local network instead of the RAN. However, the 5G-RAN still has resources reserved for the UE. Therefore, the UE SMF entity may inform the 5G-RAN in step S37 that it can release the resources reserved for the UE. Alternatively, step S38, if the UE SMF sends the UE RAN context in step S33, the 5G-RG SMF entity can also release the resources.

The 5G-RG SMF completes the procedure with steps S14-S17 from FIG. 1D in order to update the AN of possible QoS flow changes due to the nesting of the UEs SDFs in the 5G-RG PDU Session (not illustrated in FIG. 4).

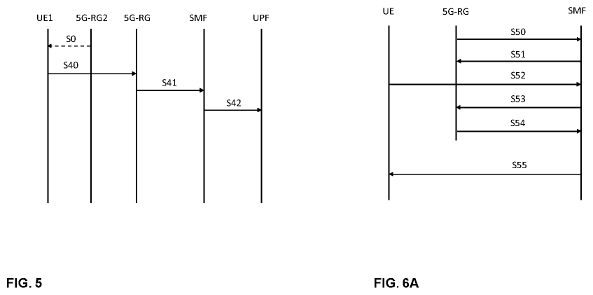

FIG. 5 is a schematic illustration of an embodiment showing some aspects of a flow mobility procedure from the perspective of the UE and a 5G-RG when the UE is moving from a further local network of a 5G-RG2 to a local network of the 5G-RG as also shown in FIG. 2C. The 5G-RG and 5G-RG2 are assumed to both have an established PDU session and to use the same session management system SMF and user plane function UPF.

In step S40, the UE1 sends an access request to the 5G-RG containing a reference that it received previously from 5G-RG2 in step S0. The reference refers to the UE1 related PDU session information in the session management context of the 5G-RG2 stored in the SMF. In one embodiment, UE1 is configured to include the reference identifying the second PDU session information in an Association Request, an ICMPv6 Router Solicitation, a DHCP Discover request or a DHCP Request request to the 5G-RG.

The 5G-RG forwards the reference to the SMF in step S41 in a PDU session modification request, where the SMF subsequently moves the PDU session information associated with UE1 to the session management context of the 5G-RG so that flows for UE1 can be continued within the PDU session of the 5G-RG. The SMF informs the UPF in step S42 so that routing is now to the 5G-RG.

As already mentioned above, in an embodiment of this disclosure, the gateway device and/or SMF may be in control when allocating addresses, e.g. IP addresses, to the UEs in order to ensure that the UE uses the same IP address within and outside the coverage of the 5G-RG. This is, for example, helpful when a UE connects to the telecommunications network prior to having connected to a local network (in which case the gateway device did not have the opportunity to assign the address to the UE) or when the UE establishes a PDU session with the telecommunications network after having been assigned an address by the gateway device.

In one embodiment, the gateway device may be deployed as an external DHCP server for the DNN, enabling the gateway device to allocate IP addresses that it may then also use in the local network.

In another embodiment, a connection exists between a DHCP server in the DNN and the gateway device, so that the gateway device is aware of the IP address assigned to a UE.

In yet another embodiment, the gateway device informs the telecommunications system (e.g. the SMF system) that it is an address assignment server, e.g. a DHCP server, during the PDU session establishment procedure of the gateway device as depicted in FIG. 1C. When a UE connects to the telecommunications network, the telecommunications network may then request an address for the UE from the gateway device. When the UE connects to the local network provided by the gateway device at a later point in time, the gateway device is aware of the assigned address and may allocate the same address.

Thus, in one embodiment, the session management system SMF may be configured for receiving and storing an indication from the 5G-RG, in a PDU session establishment request for establishing the first PDU session. The indication indicates to the SMF that the 5G-RG is available for assigning addresses to UEs. When an address is needed for a UE or 5G-RG2, the SMF may request an address from the 5G-RG in response to receiving a PDU session establishment request from the UE resp. the 5G-RG2 for the second established PDU session. The SMF may then receive the address from the 5G-RG and allocate the address to the UE resp. the 5G-RG2, for example in a PDU session establishment accept message to the UE resp. the 5G-RG2. In this embodiment, the session management system SMF is made aware of the availability of the first gateway device for address allocation or is instructed that addresses should be obtained from the first gateway device. The embodiment facilitates allocation of the same address in the local network and in the telecommunications network for the UE. Use of the same address, such as an IP address, may assist in tracing the session information to be transferred from one PDU session to another PDU session.

FIG. 6A is a schematic illustration of some steps of an address assignment scheme for a UE for a particular DNN. The UE may obtain an established PDU session on the same DNN for the flow mobility. The 5G-RG has established a first PDU Session with a DNN with an indication that it assigns IP addresses. After the UE has registered in the telecommunications network, during the establishment of a second PDU Session, the UE will then be assigned an address by the 5G-RG.

In step S50, the 5G-RG sends a PDU Session Establishment request to the SMF. The PDU Session Establishment request contains a DNN and an indication that it acts as a DHCP server for that DNN, e.g. a flag that the 5G-RG may assign IP addresses for that DNN. The SMF that receives the request will store this information that the 5G-RG is a DHCP server for the DNN and proceeds with establishing the PDU session in a regular manner, e.g. as described in more detail in 3GPP TS 23.502, v16.3.0. Step S51 is the completion of the PDU session establishment for the 5G-RG.

If, at a later point in time, the UE sends a PDU Session Establishment request to the same SMF and DNN, step S52, the SMF will find the stored information and send an address assignment request, step S53, to the 5G-RG previously stored in the SMF (for example, because this information was provided in step S50). The address assignment request also contains an identifier of the UE, so that the gateway device 5G-RG can administer for which UE the address was provided. The SMF will receive an address from the gateway device 5G-RG in an address response message, shown in step S54 for the UE.

It should be noted that steps S53 and S54 may also be used for authorization and authentication of the UE, as explained above with reference to FIGS. 3 and 4.

In step S55, the SMF sends a PDU Session Establishment Accept message with the IP address assigned by the gateway device.

The UE can provide authentication information (e.g. username, password) in the PDU establishment request, which will be forwarded to their 5G-RG acting as an external DHCP server. The 5G-RG can authenticate/authorize and provide a 5G-RG token to the UE when connected to the local network for later use during mobility. The 5G-RG token is something arranged between 5G-RG SMF and the 5G-RG, such that when the 5G-RG SMF sees the token, it knows that this has been provided by the 5G-RG to show authorization. The 5G-RG token may be generated specifically for a specific UE and specific 5G-RG (i.e. including UE ID and 5G-RG in the calculation of the token), or may be specific for the 5G-RG only (the 5G-RG has a set of generic tokens to provide). If there is a set of generic tokens, the 5G-RG can obtain these tokens in a configuration procedure with the 5G-RG SMF. If the token is UE specific, the 5G-RG will obtain and exchange the token in a procedure with the 5G-RG SMF. The token procedure may also use a different specific function (e.g. a AUSF, see FIG. 2) in the assignment. This enables both the UE SMF entity and the 5G-RG SMF entity, when these are not the same for the UE and 5G-RG, to check with this AUSF that an incoming token is correct. Another alternative is that the UE SMF stores the token in step S54. That would also allow the UE SMF entity to check the token when received from the UE. It may also be possible that the UE gets two different tokens (one from the 5G-RG SMF and one from the UE SMF) where the different SMF entities can individually show authorization of mobility of SDFs between 5G-RG and UE.

FIG. 6B is a schematic illustration of an address allocation scheme for a UE where the UE establishes a PDU session with an SMF entity that does not serve the 5G-RG. In this case, the DHCP server on the 5G-RG can be reached, for example, over the user plane UP, for example via the UPF anchor of the UE and the Data Network (N6 interface) as described in 3GPP TS 23.501, v16.3.0, clause 5.8.2.2 UE IP Address Management. The 5G-RG is dynamically assigned as an address assignment server during the 5G-RG PDU Session establishment. A configuration parameter to that extent may be distributed to all SMF entities serving a particular DNN.

In particular, in step S60, the 5G-RG sends a PDU Session Establishment request to the SMF entity of the 5G-RG comprising a DNN indication and an indication that the 5G-RG is available as a DHCP server for the DNN. The SMF entity of the 5G-RG may then find the SMF entities for the DNN, such as the SMF entity of the UE, for example by querying the NRF as in step S61A, using for example the Nnrf_NFDiscovery_Request (specified in TS 23.502, v16.3.0, clause 5.2.7.3.2 Nnrf_NFDiscovery_Request service operation) and using SMF as “NF type of the target NF” input and DNN as additional criteria for filtering (step S61A). The response to that query contains all the SMFs that serve this DNN and need to be updated with the indication that the 5G-RG is available as a DHCP server for the DNN. Subsequently, the SMF entity of the 5G-RG updates at least the SMF entity of the UE for this DNN accordingly as shown in step S61B as received from the NRF.

Step S62 indicates the PDU Session Establishment request by the UE to the SMF entity of the UE. From the update information (e.g. a configuration parameter) received from the SMF entity of the 5G-RG, the SME entity of the UE is aware that the 5G-RG is available for assigning an address to the UE. Accordingly, the SME entity of the UE sends an address assignment request for the UE to the UPF entity of the UE in step S63.

The address for the UE is subsequently obtained by the UPF entity of the UE over the user plane UP, indicated by the dashed box in FIG. 6B, as indicated in steps S64-S67.

When the UPF entity of the UE receives the address from the 5G-RG, the SMF entity provides the address to the SMF entity of the UE in step S68 that provides the address to the UE in step S69 as part of a PDU session establishment accept message.

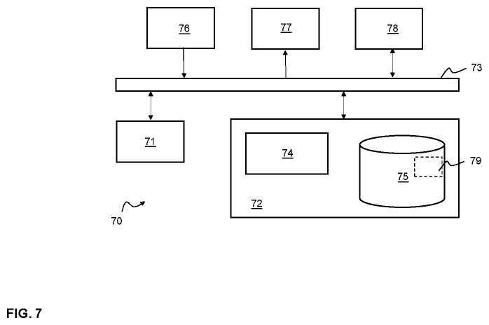

FIG. 7 depicts a block diagram illustrating an exemplary processing system according to a disclosed embodiment, e.g. a UE, session management system, a gateway device and/or a server system for performing a network function as disclosed herein. As shown in FIG. 7, the processing system 70 may include at least one processor 71 coupled to memory elements 72 through a system bus 73. As such, the processing system may store program code within memory elements 72. Further, the processor 71 may execute the program code accessed from the memory elements 72 via a system bus 73. In one aspect, the processing system may be implemented as a computer system that is suitable for storing and/or executing program code. It should be appreciated, however, that the processing system 70 may be implemented in the form of any system including a processor and a memory that is capable of performing the functions described within this specification.

The memory elements 72 may include one or more physical memory devices such as, for example, local memory 74 and one or more bulk storage devices 75. The local memory may refer to random access memory or other non-persistent memory device(s) generally used during actual execution of the program code. A bulk storage device may be implemented as a hard drive or other persistent data storage device. The processing system 70 may also include one or more cache memories (not shown) that provide temporary storage of at least some program code in order to reduce the number of times program code must be retrieved from the bulk storage device 75 during execution.

Input/output (I/O) devices depicted as an input device 76 and an output device 77 optionally can be coupled to the processing system. Examples of input devices may include, but are not limited to, a space access keyboard, a pointing device such as a mouse, or the like. Examples of output devices may include, but are not limited to, a monitor or a display, speakers, or the like. Input and/or output devices may be coupled to the processing system either directly or through intervening I/O controllers.

In an embodiment, the input and the output devices may be implemented as a combined input/output device (illustrated in FIG. 7 with a dashed line surrounding the input device 76 and the output device 77). An example of such a combined device is a touch sensitive display, also sometimes referred to as a “touch screen display” or simply “touch screen” that may be provided with the UE. In such an embodiment, input to the device may be provided by a movement of a physical object, such as e.g. a stylus or a finger of a person, on or near the touch screen display.

A network adapter 78 may also be coupled to the processing system to enable it to become coupled to other systems, computer systems, remote network devices, and/or remote storage devices through intervening private or public networks. The network adapter may comprise a data receiver for receiving data that is transmitted by said systems, devices and/or networks to the processing system 70, and a data transmitter for transmitting data from the processing system 70 to said systems, devices and/or networks. Modems, cable modems, and Ethernet cards are examples of different types of network adapter that may be used with the processing system 70.

As pictured in FIG. 7, the memory elements 72 may store an application 79. In various embodiments, the application 79 may be stored in the local memory 74, the one or more bulk storage devices 75, or apart from the local memory and the bulk storage devices. It should be appreciated that the processing system 70 may further execute an operating system (not shown in FIG. 7) that can facilitate execution of the application 79. The application 79, being implemented in the form of executable program code, can be executed by the processing system 70, e.g., by the processor 71. Responsive to executing the application, the processing system 70 may be configured to perform one or more operations or method steps described herein.

In one aspect of the present invention, one or more components of the UE, gateway device and/or system performing an SMF as disclosed herein may represent processing system 70 as described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 71 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the claims. The embodiments were chosen and described in order to best explain the principles and some practical applications of the present invention, and to enable others of ordinary skill in the art to understand the present invention for various embodiments with various modifications as are suited to the particular use contemplated.

1. A user equipment, UE, configured for controlling connection continuity in a system comprising:
a first gateway device having a first established packet data unit, PDU, session with a telecommunications network storing a first session management context for the first gateway device associated with the first established PDU session and providing a local network for a plurality of UEs using the first established PDU session of the first gateway device; and
a further device having a second established PDU session with the telecommunications network storing a second session management context associated with the second established PDU session;
wherein the UE is configured to control connection continuity by transmitting at least one of:
a PDU session modification request to the telecommunications network comprising a reference to first PDU session information in the first session management context stored in the telecommunications network for the UE to include at least part of the first PDU session information in the second session management context;
an access request to the first gateway device comprising a reference to second PDU session information in the second session management context stored in the telecommunications network to include at least part of the second PDU session information in the first session management context.

2. The UE according to claim 1, wherein the further device is a mobile UE having the second established PDU session or a stationary second gateway device providing a further local network for a plurality of UEs and having the second established PDU session.

3. The UE according to claim 1, wherein the UE is configured to determine availability of the local network and to transmit at least one of
the PDU session modification request when the local network of the first gateway device is unavailable; and
the access request when the local network of the first gateway device is available.

4. The UE according to claim 1, wherein the UE is configured for at least one of the following:
receive the at least one reference to the first PDU session information in a message from the first gateway device during connection establishment with the first gateway device or during address allocation by the first gateway device, wherein the message is, for example, an Association Response message, an ICMPv6 Router Advertisement message, a DCHP Offer message or a DHCP Ack message and;
receive the at least one reference to the second session management context in a message from the further device during connection establishment or during address allocation, for example, an Association Response message, an ICMPv6 Router Advertisement message, a DCHP Offer message or a DHCP Ack message.

5. The UE according to claim 1, wherein the UE is configured for at least one of the following:
to receive an authentication token from the first gateway device or further device and to transmit the authentication token with the PDU session modification request to the telecommunications network resp. with the access request to the further device;
to receive an authentication token from the first gateway device and the telecommunications network and determine authentication for each of the received tokens separately.

6. The UE according to claim 1, wherein the UE is configured to include the reference identifying the second PDU session information in an Association Request, an ICMPv6 Router Solicitation, a DHCP Discover request or a DHCP Request request to the first gateway device.

7. A session management system in a telecommunications network storing a first session management context associated with a first established PDU session for a first gateway device providing a local network for a plurality of UEs to enable data exchange with a data network over the telecommunications network using the first established PDU session, and storing a second session management context associated with a second established PDU session for a further device;
wherein the session management system is configured for at least one of the following:
receiving a PDU session modification request from the further device to modify the second established PDU session, wherein the PDU session modification request contains a reference to first PDU session information in the first session management context, and wherein the session management system is further configured for tracing the first PDU session information based on the reference and to include at least part of the first PDU session information in the second session management context;
receiving a PDU session modification request from the first gateway device to modify the first established PDU session, wherein the PDU session modification request contains a reference to second PDU session information in the second session management context, and wherein the session management system is further configured for tracing the second PDU session information based on the reference and to include at least part of the second PDU session information in the first session management context.

8. The session management system according to claim 7, wherein the session management system in the telecommunications network is configured to receive an address for a UE from the first gateway device and to assign the address to the UE for the second established PDU session.

9. The session management system according to claim 7, wherein the session management system is configured to execute at least one of:
performing a PDU session modification procedure to modify the first established PDU session of the first gateway device during or after modifying the second established PDU session by removing the first PDU session information included in the second session management context from the first session management context;
performing a PDU session modification procedure to modify the second established PDU session of the further device during or after modifying the first established PDU session by removing the at least one second PDU session information included in the first session management context from second session management context;
adding at least one forwarding rule in the telecommunications network corresponding to the modified first respective second PDU session; and
update the access network of the telecommunications network.

10. The session management system according to claim 7, wherein the session management system is configured for at least one of the following:
to receive an authentication token from the UE in a modification request for the second PDU session and to transmit the authentication token to the first gateway device or authentication system in the telecommunications network for authentication of the UE
to receive an authentication token from the UE in a modification request for the second PDU session and to receive the authentication token from the first gateway device to authenticate the UE.

11. The session management system according to claim 7, wherein the session management system contains a first session management entity having access to the first session management context and a second session management entity having access to the second session management context, wherein the first respective second session management entity is configured for request information from a repository to identify the second respective first session management entity storing the second respective first session management context based on the reference.

12. The session management system according to claim 7, wherein the session management system is configured for at least one of:
receiving and storing an indication from the first gateway device in a PDU session establishment request for establishing the first established PDU session of the first gateway device, the indication indicating that the first gateway device is available for assigning addresses to UEs;
requesting an address from the first gateway device in response to receiving a PDU session establishment request from the further device for the second established PDU session and receiving the address from the first gateway device;
allocating an address assigned by the first gateway device to the further device in a PDU session establishment accept message to the further device;
receiving an indication from the first gateway device in a PDU session establishment request for establishing the first established PDU session of the first gateway device, the indication indicating that the first gateway device is available for assigning addresses to UEs and distributing the indication to a plurality of entities of the session management system associated with a data network indicated in the PDU session establishment request.

13. A gateway device configured to provide a local network for a plurality of UEs and to provide a first established PDU session with a telecommunications network for data communication with a data network over the telecommunications network for the plurality of UEs, wherein the gateway device is configured for at least one of the following:
transmit a reference to first PDU session information in a first session management context stored in the telecommunications network associated with the first established PDU session to at least one of the plurality of UEs over the local network;
receive a reference to second PDU session information in a second session management context associated with a second established PDU session of a further device from a UE and transmit a PDU session modification request including the reference over the telecommunications network to include at least part of the second PDU session information in the first session management context of the first gateway device.

14. The gateway device according to claim 13, wherein the gateway device is configured for at least one of the following:
transmitting an indication to a session management system, the indication indicating that the gateway device is available for assigning addresses to UEs;
transmitting an authentication token to a UE corresponding to an authentication token stored in the telecommunications system, for example in a session management system or in an authentication system;
receiving a request from a session management system for an address for a UE and providing the address to the session management system for the UE, wherein the provided address corresponds to an address allocated in the local network of the gateway device, wherein, optionally, authenticating the UE when receiving the request for an address from the session management system and providing the address to the session management system;
allocating an address to a UE in the local network provided by the gateway device, wherein the allocated address corresponds to the address provided to the session management system.

15. A session management context data structure for storing in a 5G telecommunications network comprising an established PDU session part, wherein a service data flow, SOF, and a quality-of-service, QoS, flow are absent from the established PDU session part of the session management context data structure.
